(19) United States
(12) Patent Application Publication
(10) Pub. No.: US 2013/0094792 A1
(43) Pub. Date: Apr. 18, 2013

(54) DEVICE FOR SUPPLYING A FLUID INTO A ROLLING CHAMBER OF A ROLLING-ELEMENT BEARING

(71) Applicants: Joerg Schwartz, Potsdam (DE); Juergen Kreutzkaemper, Berlin (DE); Ingo Wagler, Witzschdorf (DE)

(72) Inventors: Joerg Schwartz, Potsdam (DE); Juergen Kreutzkaemper, Berlin (DE); Ingo Wagler, Witzschdorf (DE)

(73) Assignee: AKTIEBOLAGET SKF, Goteborg (SE)

(21) Appl. No.: 13/649,255

(22) Filed: Oct. 11, 2012

(30) Foreign Application Priority Data
Oct. 13, 2011 (DE) 10 2011 084 420.1

(51) Int. Cl. F16C 33/66

(52) U.S. Cl. CPC F16C 33/6637
USPC 384/462

(57) ABSTRACT

A rolling-element bearing assembly includes a device for supplying a fluid into a rolling chamber of a rolling-element bearing. The device includes a fluid supply ring disposed in the axial direction lateral to the rolling-element bearing, and at least one fluid conduit for conveying the fluid from the fluid supply ring into the rolling chamber. One end of the conduit protrudes into the rolling chamber so as to be disposed axially between a rotation-induced air cushion and the rolling elements and/or a raceway surface of the rolling element bearing.

### CROSS-REFERENCE

This application claims priority to German patent application no. 10 2011 084 420.1 filed on Oct. 13, 2011, the contents of which are fully incorporated herein by reference.

### TECHNICAL FIELD

The present invention generally relates to a device and a method for supplying a fluid, such as a lubricant, into a rolling chamber of a rolling-element bearing.

### BACKGROUND

Rolling-element bearings are usually lubricated with a fluid, such as e.g., oil, grease, or any other friction-reducing lubricant. The fluid is introduced into the rolling chamber of the rolling-element bearing in order to reduce or prevent wear or abrasion of the rolling elements and raceway surfaces caused by rolling and/or sliding friction. During operation, rolling elements, e.g., balls or rollers, roll between bearing rings of the rolling-element bearing in the rolling chamber. In order to prevent the lubricant from leaking out the bearing and thus not staying at the locations that require lubrication, one or more seals are also often used.

However, even if the fluid or lubricant is reliably held in the rolling chamber between the bearing rings by the seal(s), increased wear can result if the lubricant cannot reach the to-be-lubricated contact points between bearing ring or raceway and rolling elements, or if it cannot reach the contact points in sufficient quantity. In order to overcome an “air cushion” that is generated lateral to the rolling elements at high bearing rotational speeds, and thereby achieve an adequate bearing lubrication, some known solutions have used compressed air as a transport medium for the lubricant, or have used pressurized lubricant. However, such known systems increase costs, complexity and space requirements due to the need to provide a source of high pressure.

Consequently, there is a long felt need to achieve an adequate lubrication of a rolling element bearing without the need for a source of high pressure.

### SUMMARY

Therefore, it is an object of the present teachings to disclose improved roller bearing assemblies and/or techniques for overcoming one or more of the above-described problems.

In one aspect of the present teachings, a fluid, for example a lubricant, can be reliably dispensed or metered into the rolling-element bearing through the air cushion that is generated at high rotational speeds of the bearing, i.e. through the bearing-rotation-induced air cushion, thereby achieving an optimally homogenous lubricant supply and/or lubricant distribution. Neither compressed air for the lubricant transport nor highly pressurized lubricant is required in this aspect of the present teachings.

In another aspect of the present teachings, a rolling-element bearing assembly includes a device for supplying a fluid into a rolling chamber of a rolling-element bearing. For example, the rolling-element bearing assembly preferably comprises a fluid supply ring disposed lateral to the rolling-element bearing in the axial direction, i.e. in the direction of the rotational axis of the bearing. In addition, at least one fluid conduit is provided and extends into the rolling chamber so as to convey the fluid from the fluid supply ring into the rolling chamber. Rolling elements (e.g. balls, cylindrical rollers, needle rollers, barrel or tapered rollers, etc.) are disposed in the rolling chamber and roll on raceway surfaces defined by a bearing inner ring and a bearing outer ring. At high rotational speeds, a rotation-induced air cushion or air curtain (i.e. an air barrier) is generated within the rolling chamber and is located axially adjacent to the rolling elements. In order to overcome this air cushion, one end of the fluid conduit projects into the rolling chamber close enough to the rolling elements that the conduit end lies axially between the rotation-induced air cushion and the rolling elements and/or the raceway surfaces. This design allows the fluid, e.g., a lubricant, to be dispensed into the rolling-element bearing through the air cushion, and makes possible an optimal lubricant supply and distribution.

The fluid supply ring and the rolling-element bearing can for example be mounted in a bearing housing in such a way that the fluid supply ring lies directly axially against an axial end surface of the rolling-element bearing or on the axial end surfaces of the bearing inner ring and outer ring, and thus it is at least partially axially fixed to the bearing, e.g. on a shaft to be supported or borne. At least one fluid supply channel may be defined within the interior of the fluid supply ring and may extend at least substantially in the radial direction of the bearing. In the mounted or assembled (i.e. operational) state of the rolling-element bearing assembly, the fluid supply channel couples the rolling-element bearing assembly with a fluid supply reservoir and/or a micro-metering system for the fluid (e.g. lubricant), which is located radially outside the rolling-element bearing assembly or the fluid supply ring. Preferably, the fluid supply ring, as well as the axially immediately adjacently disposed rolling-element bearing, are manufactured from metal, such as for example a hardened steel.

In another aspect of the present teachings, the at least one fluid conduit is preferably rigid or stiff, i.e. at least substantially inflexible. For example, the fluid conduit can for example be manufactured from a metal. In addition or in the alternative, the conduit may have a shape corresponding to an injection-needle tube, e.g., similar to a capillary conduit, cannula or syringe needle, and may project from the fluid supply ring into the interior of the rolling chamber. At its end facing towards the fluid supply ring, the fluid conduit is coupled with the radially-extending fluid supply channel defined in the fluid supply ring, so that the fluid from the fluid supply reservoir located outside the rolling-element bearing assembly can be brought through the fluid supply channel of the fluid supply ring and through the injection needle as close as possible to the location to be lubricated, i.e. for example the rolling elements and/or the raceway surfaces inside the rolling chamber. In such an embodiment, the injection-needle-like conduit protrudes in the axial direction far enough into the bearing interior or into the rolling chamber that it penetrates through the rotation-induced air barrier (cushion).

In another aspect of the present teachings, the end of the fluid conduit that protrudes into the rolling chamber extends in a range from 0.8×(B_{L}−B_{W})/2 to 1.9×(B_{L}−B_{W})/2 from a bearing end side into the rolling-element bearing, wherein B_{L} represents an axial bearing ring width and B_{W} represents an axial rolling element width. In cylindrical roller bearings, this axial extension (length) of the fluid conduit into the rolling-element bearing interior, i.e. for example from the bearing ring edge to the bearing interior, may be, e.g., 0.85×(B_{L}−B_{W})/2 or more, wherein in this case B_{W}represents an axial cylindrical roller extension (length). For ball bearings, the axial extension (length) of the fluid conduit into the rolling-element bearing can for example be 0.9×(B_{L}−B_{W})/2 or more, wherein in this case B_{W} represents the ball diameter. In some exemplary embodiments, the length of the section of the fluid conduit protruding into the rolling chamber can also fall within the range of 1.0×(B_{L}−B_{W})/2 to 1.7×(B_{L}−B_{W})/2 from a bearing end face axially into the rolling-element bearing.

Furthermore, it can be advantageous to design the at least one fluid conduit so that it is interchangeable, replaceable or exchangeable. In this case, the shape or structure of the end of the fluid conduit protruding into the rolling chamber can be suitably selected to achieve a desired shape of the fluid drops that will be discharged from the conduit. For example, fluid conduits or injection needle points having oblique, rounded, wedge- or dovetail-shaped cross-sections may be advantageously utilized in an interchangeable, and larger or smaller fluid drops can be generated in accordance with the shape of the discharge end of the fluid conduit.

In another aspect of the present teachings, the lubricant distribution ring or the lubricant supply ring for supplying the lubricant to the bearing, e.g., rolling-element bearings, is preferably designed so that one or more capillary conduits or cannulas is/are attached axially lateral to the supply ring, and thus protrude directly into the bearing interior so as to be able to deliver or convey a lubricant in direct proximity to the location to be lubricated (e.g. a raceway surface). If the capillaries or cannulas protrude into the rolling chamber, i.e. into the volume between the inner and outer ring and/or into the cage volume, it is possible to overcome the problem of the rotation-induced air cushion around the bearing, which is especially strong when spindle rollers are used as the rolling elements and they rotate at high speeds. By appropriately arranging or designing the capillaries or channels, as well the shape and geometry of the capillary or channel ends, through which the lubricant continuously emerges, the manner and direction of the emergence or discharge of the lubricant can be directly influenced in an advantageous manner.

In another aspect of the present teachings, a method for supplying a fluid into a rolling chamber of a rolling-element bearing is disclosed. For example, a fluid supply ring may be disposed laterally in the axial direction adjacent to the rolling-element bearing, and at least one fluid conduit may extend from the fluid supply ring into the rolling chamber. Rolling elements roll on one or more raceway surfaces between a bearing inner ring and a bearing outer ring in the rolling chamber and thereby generate a rotation-induced air cushion axially adjacent to the rolling elements during operation of the rolling element bearing. Therefore, the conduit is preferably designed and disposed so as to extend far enough into the rolling chamber that the end of the conduit protruding into the rolling chamber is close enough to the rolling elements and/or the raceway surface(s) that it lies axially between the rotation-induced air cushion and the rolling elements and/or the raceway surface(s). Fluid, such as lubricant, is then conveyed through the conduit in order to lubricate the rolling elements and/or raceway surface(s) without being blocked or impeded by the air cushion that is generated during high speed operation.

In certain exemplary embodiments of the present teachings, the lubricant can be advantageously injected directly and in a targeted manner into the raceway surface region of the bearing, even at high bearing rotational speeds and thus overcome the lateral rotation-induced air cushions or barriers that “border” the rolling chamber. Since the fluid conduit protrudes axially through the volume of the rotation-induced air cushions in the rolling chamber, the lubricant can be supplied to the bearing without compressed air or lubricant pressure, which can in turn lead to a significant savings in manufacturing and operating costs as well as reduced energy consumption.

Further objects, embodiments, advantages and designs of the present teachings will be explained in the following, or will become apparent, with the assistance of the exemplary embodiments and the appended Figures.

### BRIEF DESCRIPTION OF THE DRAWINGS

FIG. 1 shows a sectional representation of a representative single-row rolling-element bearing assembly.

FIG. 2 shows a sectional representation of another representative single-row rolling-element bearing assembly having a fluid injection point between the bearing inner ring and the bearing cage.

FIG. 3 shows a sectional representation of another representative single-row rolling-element bearing assembly having a fluid injection point between the bearing outer ring and the bearing cage.

FIG. 4 shows a sectional representation of a double-row rolling-element bearing assembly.

### DETAILED DESCRIPTION OF THE INVENTION

In the following description of preferred embodiments of the present teachings, identical reference numbers will be used to designate the same or similar components.

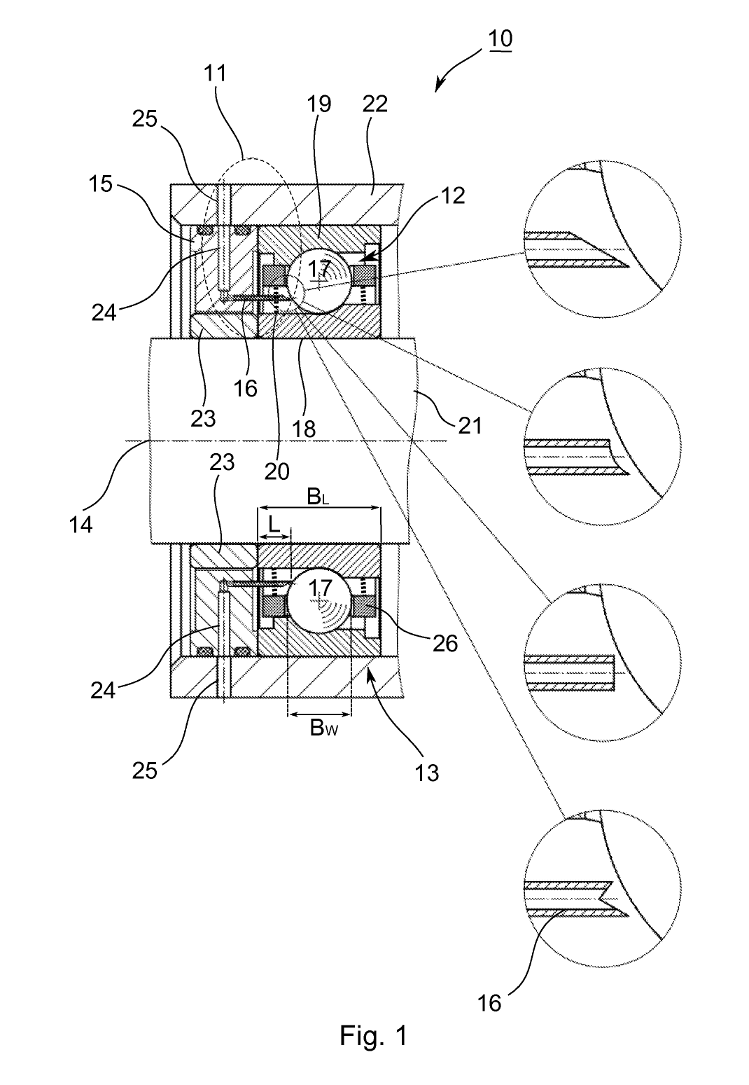

FIG. 1 shows a cross-section of a rolling-element bearing assembly 10 having a device 11 for supplying a fluid (not shown) into a rolling chamber 12 of a rolling-element bearing 13.

The rolling-element bearing assembly 10 comprises a fluid supply ring 15 that is disposed laterally in the axial direction 14 adjacent to the rolling-element bearing 13. Further, at least one fluid conduit 16 is provided for supplying the fluid from the lateral fluid supply ring 15 into the rolling chamber 12. Rolling elements 17 roll within the rolling chamber 12 on raceway surfaces respectively defined by a bearing inner ring 18 and a bearing outer ring 19, and thereby generate a rotation-induced air cushion (barrier) 20 in the rolling chamber 12 when the bearing rotates at high speed. The air cushion 20 is located adjacent to the rolling elements 17 in the axial direction. One end (i.e. the discharge end) of the fluid conduit 16 protrudes into the rolling chamber 12 and is disposed near to the rolling elements 17 and/or the raceway surface(s) in the rolling chamber 12 such that the discharge end is located axially between the rotation-induced air cushion (or air barrier) 20 and the rolling elements 17 and/or the raceway surfaces.

The angular contact ball bearing assembly 10 shown as an example in FIG. 1 serves to support or bear a shaft 21 and is bounded in the radial direction by a bearing housing 22 or its housing wall. The rolling-element or angular contact ball bearing assembly 10 is thus located radially between the shaft 21 to be supported (borne) and the bearing housing 22.

An intermediate ring 23 is fixed on the shaft 21 so as to rotate therewith and is located directly adjacent to the bearing inner ring 18 in the axial direction 14. The intermediate ring 23 at least partially fixes or immobilizes the bearing inner ring 18 on the shaft 21 in the axial direction. The fluid supply ring or fluid distribution ring 15 is located radially farther outward of the intermediate ring 23 (i.e. above in FIG. 1). The axial end surface of the fluid supply/distribution ring 15 that faces the rolling-element bearing 13 abuts directly against the adjacent axial end surface of the bearing outer ring 19, and thus the fluid supply/distribution ring 15 at least partially fixes or immobilizes the bearing outer ring 19 in the bearing housing 22 in the axial direction.

The fluid supply ring 15 has at least one radially-extending bore 24. The fluid can be transported from outside the bearing housing 22 through the bore 24 to the fluid conduit 16, which in the illustrated exemplary embodiment extends in the axial direction, i.e. the conduit 16 forms an angle of approximately 90° with the radial bore 24. The radial bore 24 of the fluid supply ring 15 can also be called a fluid supply channel and it opens radially outward into a radial housing bore 25. The fluid, e.g., a lubricant, can be conveyed from a fluid or lubricant reservoir (not shown) through the radial housing bore 25 to the fluid supply channel 24 and then into the axial fluid conduit 16, for example using a micropump, in order to eventually reach the location to be lubricated on the other side of the air barrier 20.

The fluid conduit 16 is oriented in the axial direction 14 and one end thereof protrudes axially into the rolling chamber 12 of the rolling-element bearing 13 far enough so that, when the rolling-element bearing 13 is in operation, the fluid conduit 16 penetrates through the rotation-induced air cushion or curtain 20 that is lateral to the rolling elements 17. More preferably, the end of the fluid conduit 16 that protrudes into the rolling chamber 12 extends as close as possible (without touching) to a lubrication point, such as for example a rolling element 17, a bearing cage 26 and/or a raceway surface on the inner ring 18 and/or the outer ring 19.

According to one presently preferred embodiment, the segment or portion of the fluid conduit 16 that protrudes into the rolling chamber 12 preferably has an axial extension (length) L in the range from 0.8×(B_{L}−B_{W})/2 to 1.9×(B_{L}−B_{W})/2, wherein B_{L} represents the axial bearing ring width and B_{W} represents the axial rolling-element width or the rolling-element diameter. The fluid conduit 16 thus extends with a length L of 0.8×(B_{L}−B_{W})/2 to 1.9×(B_{L}−B_{W})/2 into the rolling-element bearing 13. In other words, fluid conduit 16 and the rolling-element bearing 13 preferably overlap in the axial direction by an amount between L=0.8×(B_{L}−B_{W})/2 and L=1.9×(B_{L}−B_{W})/2.

In cylindrical roller bearings, the axial extension (length) L of the fluid conduit 16 into the rolling-element bearing interior, i.e. from the bearing ring edge into the bearing interior, can be for example L=0.85×(B_{L}−B_{W})/2 or more, wherein in this case B_{W} represents the axial extension (length) of the cylindrical roller. In ball bearings, as shown in FIG. 1, the axial extension (length) L of the fluid conduit 16 into the rolling-element bearing interior can be for example L=0.9×(B_{L}−B_{W})/2 or more, wherein in this case B_{W} represents the ball diameter.

According to another preferred embodiment, the fluid conduit 16 that extends from the radially inner-lying end of the fluid supply channel 24 in the direction of the rolling chamber 12 is formed as a rigid or stiff fluid conduit, i.e. it is at least substantially inflexible. In this case, the fluid conduit 16 can be formed as a metallic pipe conduit or another rigid hollow conduit for the fluid and may be disposed outside the bearing rings 18, 19. As is apparent from the exemplary embodiment shown in FIG. 1, the fluid conduit 16 can be formed like an injection or syringe needle, i.e. as a cannula or capillary, which extends from the fluid supply ring 15 through the rotation-induced air cushion 20 into the interior of the rolling chamber 12 and thus to a lubrication point near the rolling elements 17 or raceway(s).

On the right, FIG. 1 shows enlarged illustrations of possible designs of the conduit ends of the injection-needle-type fluid conduit 16. As was noted above, the depicted conduit ends are disposed within the rolling chamber 12. The contour of the end of the injection-needle-type fluid conduit 16 can be designed, for example, for use with different lubricants and/or to dispense different lubricant quantities. While the obliquely-extending needle point, which is indicated in the uppermost enlargement of FIG. 1, discharges relatively large lubricant droplets, the injection needle 16 ending in a dovetail-shape as shown in the lowermost enlargement is more suitable for smaller lubricant droplets.

In order to provide a rigid fluid conduit 16 that discharges the desired fluid drop shape and/or quantity, the at least one fluid conduit 16 is preferably exchangeable or detachably attached. That is, the fluid conduit 16 can be coupled with the fluid supply channel 24, for example using a detachable connection (e.g. a screw connection). Therefore, the fluid conduit 16 is replaceable and different designs of fluid conduit 16 can be easily utilized in order to provide optimal lubrication conditions for a particular application of the present teachings.

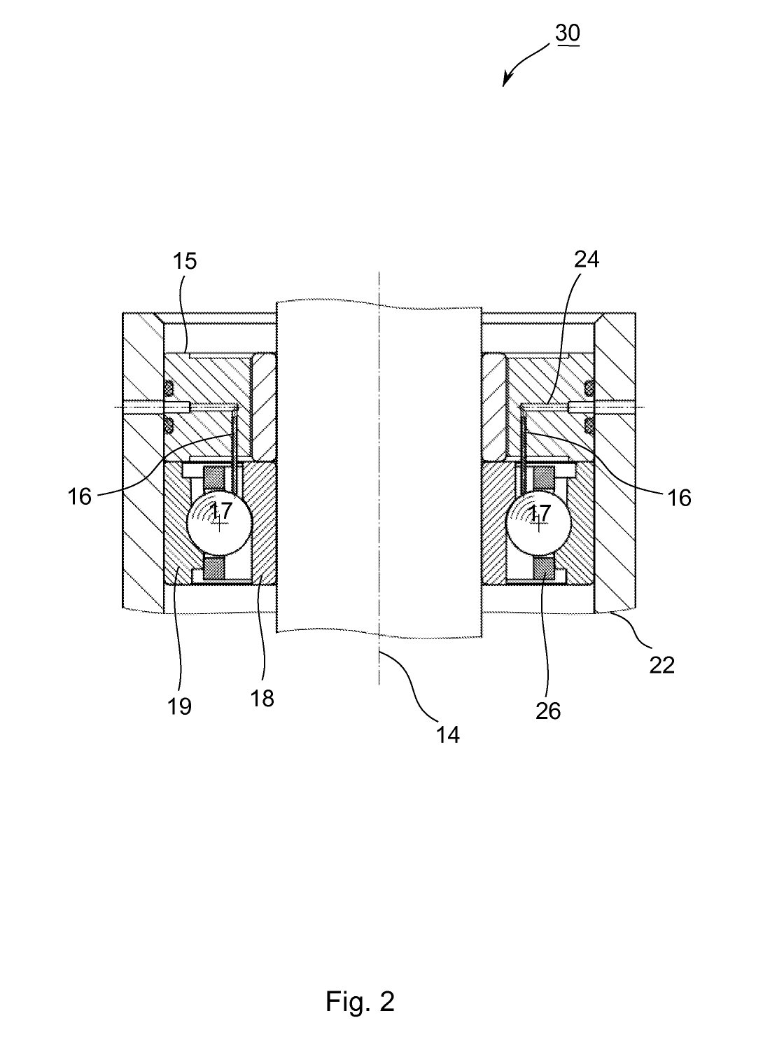

While FIG. 1 shows an exemplary embodiment of a single-row rolling-element bearing assembly 10 in a horizontal installation/operating position, FIG. 2 shows a single-row rolling-element bearing assembly 30 disposed in a vertical installation/operating position.

In the exemplary embodiment of the rolling element bearing assembly 30 shown in FIG. 2, the rigid fluid injection needle 16 also extends substantially parallel to the rotational axis (axial direction) 14 of the bearing 13 from the fluid supply channel 24 of the fluid supply ring 15 to immediately before a to-be-lubricated outer surface of the rolling elements 17, which roll in a rolling chamber 12 between inner and outer rings 18, 19 of the bearing 13. Similar to the exemplary embodiment shown in FIG. 1, the fluid injection needle 16 ends or terminates within a radially-inward rolling chamber volume between the bearing inner ring 18 and the bearing cage 26.

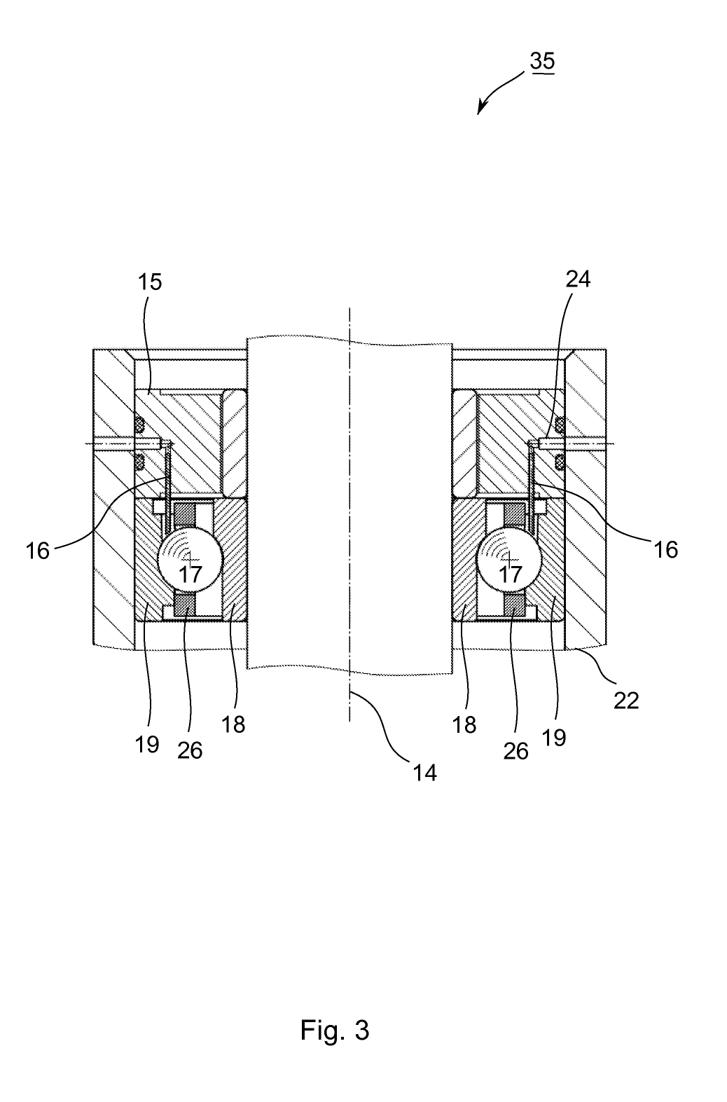

The exemplary embodiment 35 shown in FIG. 3 is also disposed in a vertical installation/operating position and differs from the exemplary embodiment 30 shown in FIG. 2 merely in that the fluid or lubricant injection needle 16 disposed between the bearing outer ring 19 and bearing cage 26 is inserted so as to be directly adjacent to the rolling-element outer surface; however the needle 16 does not touch the surface. The fluid injection needle 16 thus ends or terminates within a radially-outward rolling chamber volume between the bearing outer ring 19 and the bearing cage 26.

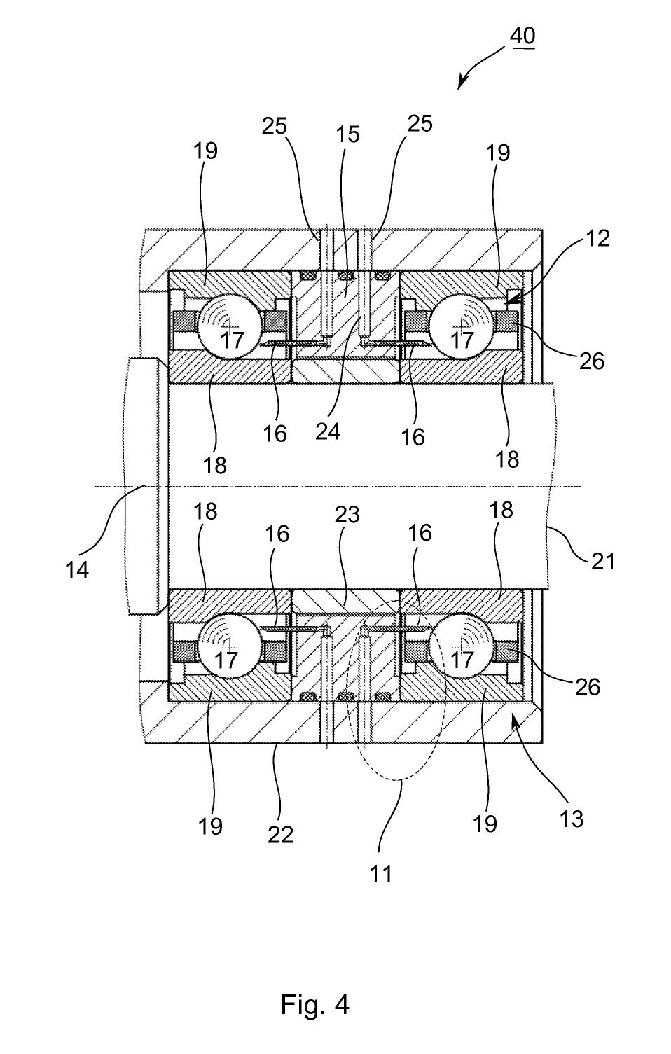

While exemplary embodiments having single-row rolling-element bearings were described with reference to FIGS. 1 to 3, FIG. 4 shows a sectional representation of a representative double-row rolling-element bearing assembly 40.

In this embodiment, one device 11 for supplying a fluid (e.g., lubricant) into the rolling chamber 12 is associated with each of the two rolling element rows. The two fluid or lubricant injection needles 16 for the two axially adjacent rolling element rows are respectively coupled with two fluid supply channels 24 defined in the fluid supply ring 15, and are oriented in opposing axial directions. That is, the two fluid supply channels are separate from each other. In this embodiment, the at least substantially rigid fluid or lubricant conduits 16 also end for example at the surface of the rolling elements (however, without touching them) between the bearing inner ring 18 and the bearing cage 26, i.e. in the radially-inward rolling chamber volume.

Naturally other embodiments of the present teachings are also conceivable. For example, the fluid conduits 16 could also extend oblique to the rotational axis (axial direction) 14 of the bearing 13, and for example could end in direct proximity to the bearing inner ring 18 or to the bearing outer ring 19, in order to be able to better lubricate the rolling element raceway surfaces defined therein. Also in such exemplary embodiments, the oblique fluid conduit could protrude in the axial direction far enough into the rolling chamber of the rolling-element bearing that, during operation of the rolling-element bearing, the fluid conduit penetrates or passes through the rotation-induced air cushion or curtain that is lateral to the rolling elements. The end of the fluid conduit, from which the fluid is discharged, is thus disposed between the air cushion and the rolling elements in the axial direction.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved roller bearing assemblies, devices for supplying fluid thereto and methods for manufacturing and using the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

10 Rolling-element bearing assembly
11 Device for supplying a fluid (e.g., lubricant) into a rolling chamber
12 Rolling chamber
13 Rolling-element bearing
14 Rotational axis (axial direction) of the bearing 13
15 Fluid supply ring
16 Fluid conduit
17 Rolling elements
18 Bearing inner ring
19 Bearing outer ring
20 Air cushion
21 Shaft
22 Bearing housing
23 Intermediate ring
24 Bore, fluid supply channel
25 Bearing housing bore for fluid
26 Bearing cage
30 Rolling-element bearing assembly
35 Rolling-element bearing assembly
40 Rolling-element bearing assembly

1. A rolling-element bearing assembly comprising:
at least one rolling element bearing having at least one inner ring, at least one outer ring, a rolling chamber defined between the inner and outer rings and a plurality of rolling elements disposed within the rolling chamber, the rolling elements generating a rotation-induced air cushion in the rolling chamber axially adjacent to the rolling elements during operation,
a fluid supply ring disposed lateral to the rolling-element bearing and on an opposite side of the rotation-induced air cushion, and
at least one fluid conduit configured to convey a fluid from the fluid supply ring through the air cushion into the rolling chamber, wherein a discharge end of the conduit protrudes into the rolling chamber and is disposed close enough to the rolling elements and/or to at least one raceway surface, such that the discharge end of the conduit is disposed axially between the rotation-induced air cushion and the rolling elements and/or the at least one raceway surface.

2. The rolling-element bearing assembly according to claim 1, wherein:
the rolling-element bearing has an axial bearing width B_{L} and an axial rolling element width B_{W}, and
the discharge end of the conduit that protrudes into the rolling chamber extends axially from a bearing end side into the rolling-element bearing over a length L within the range of [0.8×(B_{L}−B_{W})/2]≦L≦[1.9×(B_{L}−B_{W})/2].

3. The rolling-element bearing assembly according to claim 2, wherein the at least one fluid conduit is configured as an injection needle, which extends from the fluid supply ring into the interior of the rolling chamber.

4. The rolling-element bearing assembly according to claim 3, wherein the at least one fluid conduit is detachably attached to the fluid supply ring.

5. The rolling-element bearing assembly according to claim 4, wherein an end of the at least one fluid conduit opposite of the discharge end is in fluid communication with a fluid supply channel defined in the fluid supply ring, the fluid supply channel extending radially out of the fluid supply ring.

6. The rolling-element bearing assembly according to claim 5, wherein a radially outward end of the fluid supply channel is configured to be coupled with a fluid supply reservoir and/or a micro-metering system for the fluid.

7. The rolling-element bearing assembly according to claim 6, wherein the rolling elements are spindle rollers.

8. The rolling-element bearing assembly according to claim 7, wherein the fluid is a lubricant suitable for the rolling-element bearing.

9. The rolling-element bearing assembly according to claim 1, wherein the at least one fluid conduit is configured as an injection needle, which extends from the fluid supply ring into the interior of the rolling chamber.

10. The rolling-element bearing assembly according to claim 1, wherein the at least one fluid conduit is detachably attached to the fluid supply ring.

11. The rolling-element bearing assembly according to claim 1, wherein an end of the at least one fluid conduit opposite of the discharge end is in fluid communication with a fluid supply channel defined in the fluid supply ring, the fluid supply channel extending radially out of the fluid supply ring.

12. The rolling-element bearing assembly according to claim 11, wherein a radially outward end of the fluid supply channel is configured to be coupled with a fluid supply reservoir and/or a micro-metering system for the fluid.

13. The rolling-element bearing assembly according to claim 1, wherein the rolling elements are spindle rollers.

14. The rolling-element bearing assembly according to claim 1, wherein the fluid is a lubricant suitable for the rolling-element bearing.

15. A method for lubricating the rolling-element bearing assembly according to claim 1, comprising:
rotating the at least one roller bearing element at high speed, wherein an air cushion is generated lateral to the rolling elements, and
supplying a lubricating fluid through the fluid supply ring and the at least one fluid conduit such that the lubricating fluid passes through the air cushion via the at least one fluid conduit and into the rolling chamber of the at least one roller bearing element.

16. A method for manufacturing the rolling-element bearing assembly according to claim 1, the method comprising:
disposing the fluid supply ring axially adjacent to the at least one rolling-element bearing; and
fluidly coupling the at least one fluid conduit to the fluid supply ring such that the at least one fluid conduit projects into the rolling chamber defined within the at least one rolling-element bearing and extends through the rotation-induced air cushion axially adjacent to the rolling elements, wherein the discharge end of the at least one fluid conduit lies axially between the rotation-induced air cushion and the rolling elements and/or at least one raceway surface of the at least one rolling element bearing.
